(19) United States
(12) Patent Application Publication
(10) Pub. No.: US 2024/0118545 A1
(43) Pub. Date: Apr. 11, 2024

(54) Augmented Reality Device

(71) Applicant: PRAZEN CO., LTD., Gyeonggi-do (KR)

(72) Inventor: Heekyung KIM, Gyeonggi-do (KR)

(21) Appl. No.: 18/011,784

(22) PCT Filed: Aug. 20, 2021
(86) PCT No.: PCT/KR2021/011138

§ 371 Date: Dec. 20, 2022

(51) Int. Cl. G02B 27/01

(52) U.S. Cl. CPC G02B 27/0172; G02B 2027/0118; G02B 2027/0174

(57) ABSTRACT

In an augmented reality device including a micro-display, a transfer optical system that transmits light from the micro-display to a predetermined path, a diffractive optical element and/or a holographic optical element, a device including a quantum dot is disposed in one of the paths of image light incident from the micro-display to a diffractive optical element and/or a holographic optical element.

### TECHNICAL FIELD

The present invention relates to an augmented reality device, and more particularly, to an augmented reality device employing a quantum dot device to reduce the size and weight of an optical system and to make images clearer.

### BACKGROUND

Augmented Reality (AR) is a field of virtual reality (VR), which is a computer graphics technique that synthesizes virtual objects or information in an actual environment to make them look like objects existing in the original environment. When a virtual image superimposed in real time with an object in the real world has a very high sense of reality, the wearer of the augmented reality device can reach a degree where it is difficult to distinguish between an image in the real world and a virtually implemented image. It is also called Mixed Reality (MR). Augmented reality technology is a hybrid VR system that fuses a real environment and a virtual environment, and research and development are currently being actively conducted in many countries.

Augmented reality technology, a concept that supplements the real world with the virtual world, is implemented by overlapping virtual image information made of computer graphics and the like onto the real environment. The virtual image serves to enhance the visual effect of a specific element in the real environment or to display information related to the real world. Such augmented reality technology is applied to displays mounted on wearable devices such as glasses or helmets. Devices such as augmented reality glasses not only include all the functions of current smart phones, but also have functions that maximize the wearer's ability to perceive visual information. With the prospect that all computing interfaces will become augmented reality displays in the future, major global companies such as Apple, Google, and Facebook are making huge investments and developing them.

Augmented reality devices can perform their functions most effectively when worn, and it is urgently needed in the industry to develop an optical system that provides visually large and clear augmented reality images while miniaturizing augmented reality devices.

FIG. 1 is a diagram schematically showing an example of an optical system of a conventional augmented reality device.

As can be seen in FIG. 1, the optical system of the augmented reality device includes a micro-display 1 as an image source, and a transmission optical system 2 composed of one or more lenses, receiving image light, reflecting it from the inside, and passing it to the eye.

The micro-display 1 used as the image source may be an LCOS (Liquid Crystal On Silicon) display, Organic Light Emitting Diode (OLED), or the like. In FIG. 1, an example in which the LCOS is used as a micro

-display is described.

In the transmission optical system, a waveguide method, a direct projection method employing a projection method, a prism method, and the like may be used, but an example using the prism method will be described in FIG. 1.

When image light is incident from the LCOS display 1 to the prism which is the transmission optical system 2, the incident image light is reflected inside the prism and reaches the user's eyes as shown in FIG. 1. At this time, the image 3 is implemented and displayed in the space at a certain distance in front of the user's eyes.

In order for the image light to form a clear image in front of the user's eyes while performing the internal reflection of the optical system, it is necessary to minimize aberration generated during image formation and minimize image distortion. To this end, at least one surface of the prism constituting the optical system is specially designed and processed into a spherical surface, an aspherical surface, or a free curved surface. Aberrations generated during image formation in the optical system cause a decrease in sharpness. In general, the higher the sharpness in the optical design, the higher the distortion of the image, and there occurs a tradeoff that when the distortion is improved, the sharpness of the image is lowered.

As a means to secure high sharpness by suppressing aberrations while reducing the distortion of the image formed in the eye through the augmented reality optical system, a diffractive optical element (DOE) or a holographic optical element (HOE) is used as a reflection method or a transmission method in a part of the optical path of the optical system.

Diffractive optical elements or holographic optical elements are in the form of very thin films or structures, and they have advantages of enabling image formation without aberrations and further improving aberrations that cannot be controlled by special optical surfaces such as aspheric and free curved surfaces. The diffractive optical elements or holographic optical elements play a role in enhancing the resolution of an image in an augmented reality optical system to make the sharpness clear.

The diffractive optical elements or holographic optical elements are the element that uses a diffraction phenomenon by forming periodic structures in the thickness or refractive index of an optical medium to control light in an optical system.

The diffractive optical element is a device made to have a lattice structure like a grating, having a rectangular or wedge-shaped periodic cross-section through mechanical processing to form periodic structures having a period of several nm to hundreds of nm in the thickness of an optical medium in order to control light in an optical system.

The holographic optical element is a device processed and manufactured to have the shape of a film with a periodic arrangement of the refractive index by utilizing optical interferometry using one or more lasers for a photoreactive optical medium to form periodic structures in the refractive index of an optical medium in order to control light in an optical system.

Meanwhile, in order to use a diffractive optical element or a holographic optical element in augmented reality devices and the like, it is required that the diffraction efficiency is high, for example, 60% or more. The diffraction efficiency is calculated by measuring the intensity of diffracted light compared to the total intensity of incident light. For example, when reproducing a hologram, the diffraction efficiency refers to the ratio of the intensity 11 of the 1st order diffraction wave of the hologram to the intensity 10 of the illumination wave. When this diffraction efficiency is low, for example, 60 percent or less, the loss of light is severe and the brightness of the AR image is severely lowered, so that image visibility and power efficiency of the augmented reality device are greatly reduced and therefore it is meaningless to apply it.

As shown in FIGS. 2 and 3, it is theoretically and experimentally well known that in order to increase the diffraction efficiency 8 of a diffractive optical element or a holographic optical element, it is required that the bandwidth of the wavelength spectrum of light incident on the element be small.

FIG. 2 is a diagram showing a diffraction efficiency calculation model in a diffractive optical element DOE or a holographic optical element HOE, and FIG. 3 is a diagram illustrating a diffraction efficiency calculation model of a transmissive diffraction element and a diffraction efficiency calculation model of a reflective diffraction element.

Meanwhile, the diffraction efficiency calculation formula for the transmissive diffraction element is as shown in Equation 1 below, and the diffraction efficiency calculation formula for the reflective diffraction element is as shown in Equation 2 below.

$${η}_{T} ( Δ λ ) = \frac{{sin}^{2} ( \frac{π d}{sin {θ}_{0}} ( \sqrt{{( \frac{Δ n}{{λ}_{0}} )}^{2} + {( \frac{{f}^{2} Δ λ}{2 {n}_{0}} )}^{2}} ) )}{1 + {( \frac{{f}^{2} {λ}_{0} Δ λ}{2 {n}_{0} Δ n} )}^{2}} . \qquad [ Equation 1 ]$$

$${η}_{R} ( Δ λ ) = {[ 1 + \frac{1 - {( \frac{{λ}_{0} {f}^{2} Δ λ}{2 {n}_{0} Δ n} )}^{2}}{{sinh}^{2} \sqrt{{( \frac{2 π {n}_{0} d Δ n}{{λ}_{0}^{2} f} )}^{2} - {( \frac{π df Δ λ}{{λ}_{0}} )}^{2}}} ]}^{- 1} . \qquad [ Equation 2 ]$$

At this time, the arguments in each formula are as follows.

θ: Diffraction Efficiency, f=1/M, spatial frequency of grating DOE, A: period of the grating, μ: wavelength, Δμ: wavelength deviation, d: thickness, n: refractive index.

As described above, the diffraction efficiency of the DOE or HOE applied to the augmented reality optical system is highly dependent on the variation of the wavelength of light incident on the device, that is, the line width Δμ, and the smaller the line width of the wavelength of the incident light, the higher the diffraction efficiency.

Among the micro-displays used in augmented reality optical devices, there are LCOS, micro-OLED, inorganic LED, DMD, and the like.

FIG. 4 is a diagram showing the wavelength spectrum of image light emitted from the LCOS micro-display, and FIG. 5 is a diagram showing the wavelength spectrum of image light emitted from the OLED micro-display.

As can be seen in FIG. 4, the LCOS micro-display uses an LED as a backlight, and it can be seen that the wavelength spectrum of the LED light is relatively and widely distributed from the central wavelength for each color of R, G, and B.

As can be seen in FIG. 5, it can be seen that the wavelength spectrum of the OLED micro-display also has a very wide bandwidth for each center wavelength of R, G, and B.

Commercial LCOS displays are composed of components such as LED backlight, polarizing film, compensation film, and color filter, and the wavelength line width of the emission spectrum is somewhat narrower compared to the emission line width of the OLED display's emission spectrum. Therefore, when LCOS image light is incident on DOE or HOE in AR glass, relatively high diffraction efficiency can be obtained compared to when OLED image light is incident on DOE or HOE. Since the image light of the OLED display has a relatively wide line width, the diffraction efficiency is significantly lowered when it is incident on the DOE or HOE.

In other words, when an LCOS display is used in an augmented reality device, it is possible to obtain an effect of reducing optical aberration by using DOE or HOE without significantly impairing light efficiency of the entire device. However, since the LCOS display requires the application of complex parts such as an LCD panel, an LED light emitting unit, a polarizing film, a compensation film, and a recycling film, the overall volume becomes large. Due to this, it is very unfavorable to apply it to a wearable augmented reality device that seeks light weight and miniaturization.

In a wearable augmented reality device, it is absolutely necessary to reduce the volume and weight of the device. It is very advantage, as a micro-display element applied to the wearable augmented reality device, to replace the bulky LCOS and apply OLED micro display that is ¼ smaller in volume than the LCOS. However, in the case of using an OLED display, as described above, image light having a relatively wide bandwidth emitted from the micro-OLED is incident to the DOE or HOE element, resulting in a rapid decrease in diffraction efficiency. Therefore, the optical efficiency of the overall device is lowered, and it is impossible to obtain an effect of reducing optical aberrations using DOE or HOE.

In fact, although combining OLED with DOE or HOE is most desirable for light weight, miniaturization and high-definition images, there is no case of launching or announcing a product with this combination in the current augmented reality device manufacturing industry due to the above limitations.

Therefore, a means for narrowing the line width of the wavelength of the micro-OLED is required to increase the diffraction efficiency of DOE or HOE device that reduces aberrations and implements high-definition images while using micro-OLED for miniaturization of augmented reality devices.

Further, even in the case of other micro displays with a wide light emission spectrum such as micro-LED and MEMS displays, in addition to micro-OLED in augmented reality devices, a means to reduce the line width of the light emission spectrum of the display is needed to increase the diffraction effect of DOE and HOE devices that reduce aberrations and provide high-definition images. As described above, even when an LCOS display with a relatively narrow light emission spectrum is applied in an augmented reality device, a means of further reducing the line width of the light emission spectrum of the display is needed to enhance the diffraction effect of DOE and HOE elements that reduce aberrations and provide high-definition images.

### DISCLOSURE

### Technical Problem

The present invention provides, in an augmented reality optical system to which micro-display devices such as micro-OLED, LCOS, micro-LED, and MEMS display are applied, a quantum dot-adopted augmented reality device that the line width of image light incident on the DOE and HOE is dramatically reduced and therefore has the effect of improving the diffraction efficiency of DOE and HOE by 60% or more, in case that an optical element including a high efficiency quantum dot or quantum rod to reduce the wavelength line width of the micro-OLED light is introduced between the light emitting surface of a micro-display and the DOE and/or HOE, or on one side of an optical component therebetween.

### SUMMARY

According to an aspect of the present invention, there is provided an augmented reality device including a micro-display, an optical system to transfer the light from the micro-display via a predetermined light path, a diffractive optical element and/or a holographic optical element, wherein an element including a quantum dot material is disposed at one position of the paths of the light that is emitting from a micro-display and that is incident to a diffractive optical element and/or a holographic optical element.

Preferably, the micro-display may include one of an OLED, a LCOS, a LCD, a DMD, an inorganic LED, a laser beam scanning mirror type display, and a fiber scanning type display.

Preferably, the diffractive optical element may be an element in which a height pattern of a one-dimensional or two-dimensional grating structure is formed using an optical material.

Preferably, the holographic optical element may be an element in which a refractive index distribution pattern of a one-dimensional or two-dimensional grating structure is formed using an optical material.

Preferably, the element including the quantum dot may include a device made of a material with a molecular unit size of tens of micrometers or less that exhibits a photoluminescence phenomenon based on quantum mechanical energy level splitting, including a CdSeS/ZnS alloyed quantum dot, CdSe/ZnS core-shell type quantum dot, CdSe/ZnS core-shell type quantum dot, CdTe core-type quantum dot, PbS core-type quantum dot, perovskite series quantum dot such as cesium lead halide, and a quantum dot made of compounds that does not contain Cd.

Preferably, the element including the quantum dot is an element dispersed in a polymer or glass material and provided in the form of a film, a coating or a plate.

Preferably, the element including the quantum dot may be included in the form of a dispersion inside the micro-display or on the substrate, or in the form of a coating or a film.

Preferably, the transmission optical system may include an optical system composed of one of more elements of spherical, aspherical, or free curved lens, a prism or a mirror, a free space reflection mirror type optical system, a beam splitter type optical system, a reflective or transmissive pin-hole type optical system, a waveguide type optical system, a waveguide type optical system having a patterning structure or a mirror array structure, and a bird-bath-type optical system.

According to other aspect of the present invention, there is provided an augmented reality device of an all-in-one type or a tethered type.

### Advantageous Effects

According to the present invention, in an augmented reality optical system to which micro-display devices such as micro-OLED, LCOS, micro-LED, and MEMS display are applied, a quantum dot-adopted augmented reality device that the line width of image light incident on the DOE and HOE is dramatically reduced and therefore has the effect of improving the diffraction efficiency of DOE and HOE by 60% or more, in case that an optical element including a high efficiency quantum dot or quantum rod to reduce the wavelength line width of the micro-OLED light is introduced between the light emitting surface of a micro-display and the DOE and/or HOE, or on one side of an optical component therebetween.

According to the present invention, even when a micro-display having a wide line width is applied to the display device of a wearable augmented reality device, since it is possible to effectively reduce aberrations and obtain high diffraction efficiency by DOE and HOE, the overall augmented reality device It becomes possible to provide augmented reality images with high clarity along with light weight and miniaturization. This greatly contributes to the commercialization of wearable augmented reality devices.

### DESCRIPTION OF DRAWINGS

FIG. 1 is a diagram schematically showing an example of an optical system of a conventional augmented reality device.

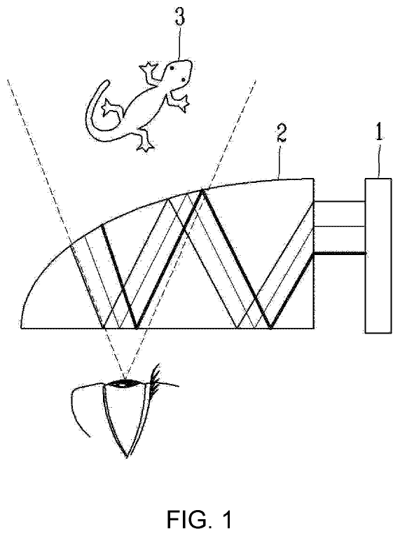

FIG. 2 is a diagram illustrating a diffraction efficiency calculation model in a diffractive optical element (DOE) or a holographic optical element (HOE).

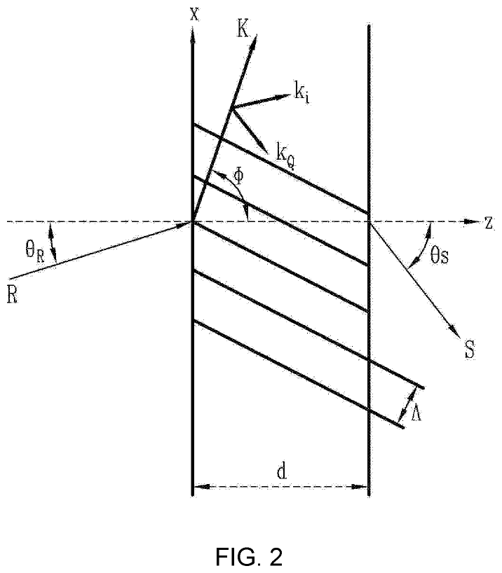

FIG. 3 is a diagram illustrating a diffraction efficiency calculation model of a transmissive diffraction element and a diffraction efficiency calculation model of a reflective diffraction element.

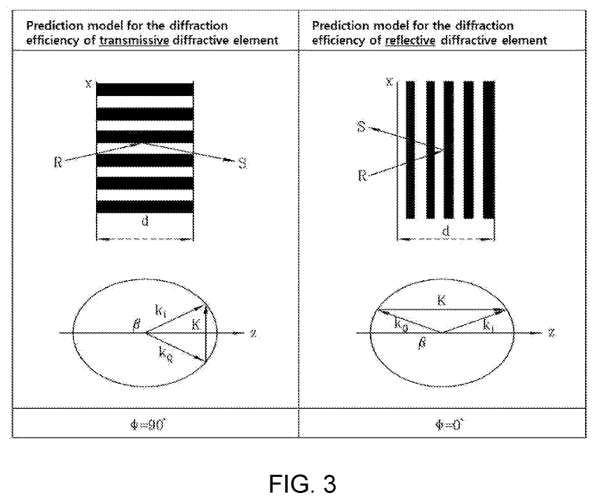

FIG. 4 is a diagram showing a wavelength spectrum of image light emitted from an LCOS micro-display.

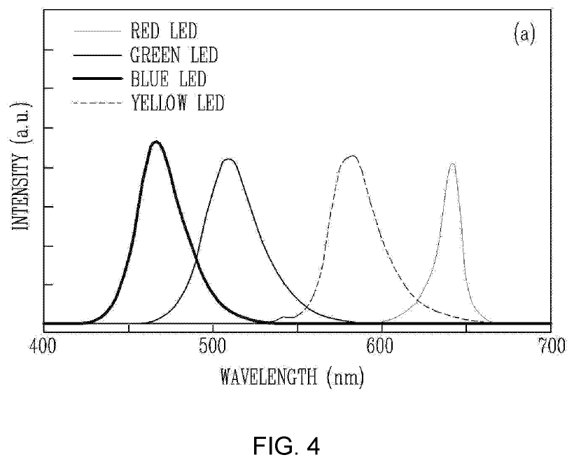

FIG. 5 is a diagram showing a wavelength spectrum of image light emitted from an OLED micro-display.

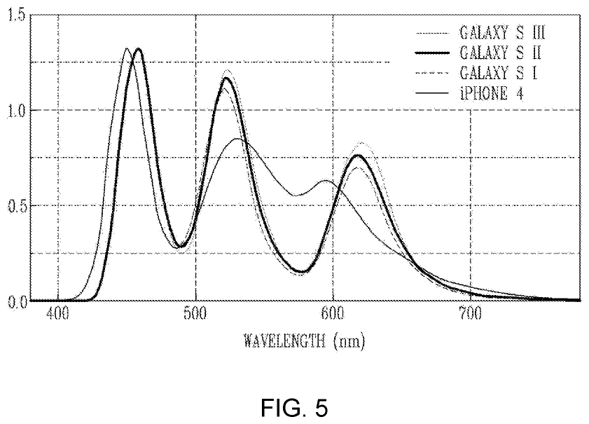

FIG. 6 is a diagram showing narrow emission spectra of two types of Perovskite QD (CH₃NH₃Pb(I₁ₓBrₓ)₃ and CH₃NHPbBr₃) applied to reduce the line width of image light of the micro-display of the present invention.

FIG. 7 is a diagram schematically illustrating an optical system of an augmented reality device according to the present invention.

FIG. 8 is a diagram schematically showing a configuration in which an HOE or a DOE is attached to one surface of a micro-display in an optical system of an augmented reality device according to the present invention.

FIG. 9 is a diagram showing an AR optical system structure of the present invention that increases the diffraction efficiency of a holographic optical element or diffractive optical element by installing a quantum dot (QD) film on the front surface of a micro-OLED element and reducing the line width in a prism coupler-type augmented reality optical system.

FIG. 10 is a diagram schematically showing an optical system of an augmented reality device including a reflective combiner 6 in a free space optical system method.

FIG. 11 is a drawing schematically showing a construction in which a holographic optical element or a diffractive optical element 4 is attached to one surface of a reflective combiner 6 in the optical system of the augmented reality device including the reflective combiner 6, in the free space optical system method.

FIG. 12 is a drawing showing a structure in which the diffraction efficiency of the holographic optical element or the diffraction optical element 4 is increased by installing the quantum dot element 5 on the front surface of the micro-display 1 and reducing the line width, in the free space optical system method.

FIG. 13 is a drawing showing the basic structure of the present invention in which a quantum dot element 5 is disposed in an optical path between a micro-display 1 and a holographic optical element or diffraction optical element 4, in the augmented reality device according to the present invention.

FIG. 14 is a diagram showing that the quantum dot element 5 is disposed in the optical path between the micro-display 1 and the holographic optical element or the diffractive optical elements 4, in case that the holographic optical element or diffractive optical element 4 is located between the transmission optical system 2 and the augmented reality image 3, in the augmented reality device according to the present invention.

FIG. 15 is a diagram showing a case where the quantum dot element 5 is located in the inner active layer of the micro-display 1 in the augmented reality device according to the present invention.

FIG. 16 is a diagram showing a case where the quantum dot element 5 is located inside the substrate of the micro-display 1 in the augmented reality device of the present invention.

### DETAILED DESCRIPTION

Hereinafter, a preferable embodiment of the present invention is described in detail with reference to accompanying drawings. The embodiment(s) is intended to aid understanding of the invention, but do not limit the present invention to the exemplified embodiment(s). It is understood that the scope of the present invention is limited only by the claims described below.

In the present invention, when a material including quantum dots, for example, a quantum dot film is disposed between a micro-display such as an OLED, LCOS, micro-LED, or MEMS display and a transmission optical system, it becomes possible to modulate the output light emitted from the micro-display with a wide bandwidth into light with a narrow bandwidth. Thus, the diffraction efficiency of the diffractive optical element disposed at the rear end of the quantum dot film can be increased. As a result, the aberration of the image light passing through the transmission optical system is reduced and it is possible to implement a clear image.

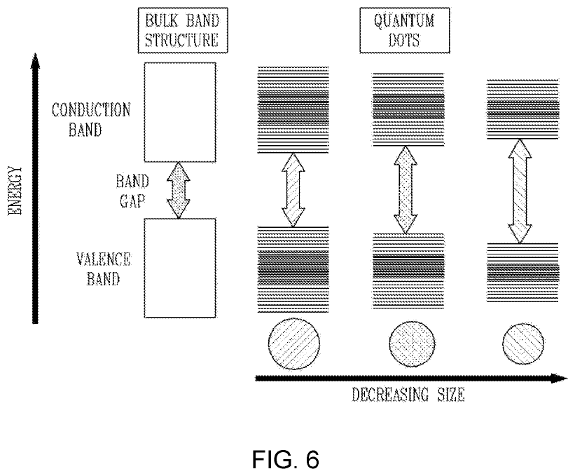

A quantum dot is a semiconductor crystalline material smaller than several tens of nanometers (nm) and is a particle that has unique electrical and optical properties. When light is irradiated on quantum dot particles, as shown in FIG. 6, a photo luminescence phenomenon occurs in which the quantum dot absorbs the incident light and emits light corresponding to different and unique energy band gaps depending on the semiconductor properties inherent in the material of the quantum dot and the size of the quantum dot.

Quantum dot materials applicable in the present invention include conventional CdSeS/ZnS alloyed quantum dots, CdSe/ZnS core-shell type quantum dots, CdSe/ZnS core-shell type quantum dots, CdTe core-type quantum dots, PbS core-type quantum dot. In addition, perovskite-based quantum dots (QD) known to have high luminous efficiency can be used, such as cesium lead halide (CsPbBr₃) perovskite quantum dots.

Since the quantum dot used in the augmented reality device of the present invention is very difficult to handle as a particle of several tens of micrometers, the quantum dot is mixed with a polymer material capable of forming a film to make an optical device using the physical properties of the quantum dot. In the form of a film, it is made into a thin film form that sharpens the color and is conveniently applied to one of the light paths of the augmented reality device.

Even when the wavelength band of light irradiated onto the quantum dot is wide, the wavelength band width of light emitted by the quantum dot becomes dramatically narrowed. Since the quantum dot material has a very narrow line width, it provides vivid color images on the display.

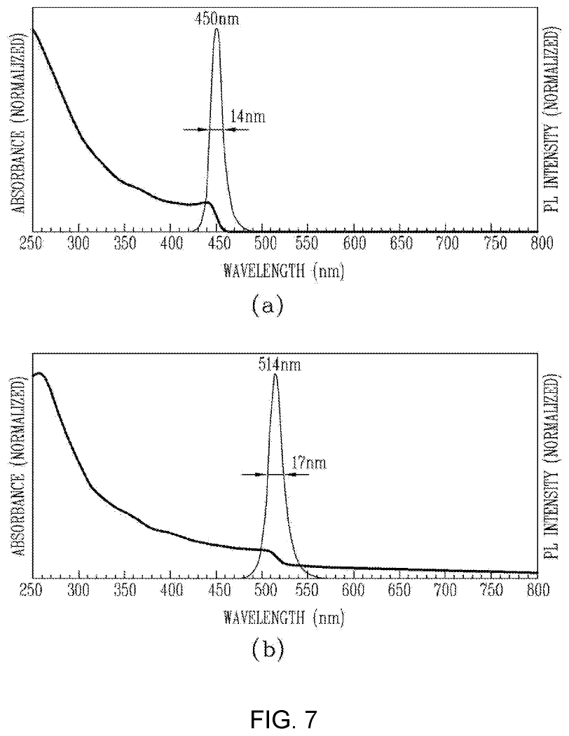

FIG. 7 exemplarily shows that two types of perovskite QD materials (CH₃NH₃Pb(I₁ₓBrₓ)₃ and CH₃NHPbBr₃) having a very narrow bandwidth and high luminous efficiency among quantum dots exhibit narrow emission spectra.

Since the quantum dot used in the augmented reality device in the present invention is very difficult to handle as a particle of several tens of micrometers, the quantum dot is mixed with a polymer material capable of forming a film to make an optical device using the physical properties of the quantum dot. It is made into a film form and made into a thin film form that sharpens the color and is conveniently applied to one of the light paths of the augmented reality device.

The micro-displays applied to the augmented reality device in the present invention include micro-OLED, LCOS, micro-LED, DMD (digital micromirror device), fiber scanning display, MEMS scanning mirror display, etc., which have light emission spectrum of all wide bandwidths required to sufficiently increase the diffraction efficiency of DOE and HOE elements for reducing aberrations of an augmented reality device display, by narrowing the light emitting line width of the output light emitted from the display.

In the present invention, the material of the quantum dot film that reduces the luminous bandwidth of the micro-display applied to the augmented reality device includes the traditional CdSeS/ZnS alloyed quantum dots, CdSe/ZnS core-shell type quantum dots, CdSe/ZnS core applicable in the present invention-shell type quantum dots, CdTe core-type quantum dots, and PbS core-type quantum dots, which can be applicable in the present invention. In addition, quantum dots made of compounds that do not contain Cd, which have recently been developed as environmentally friendly materials, can be used. In addition, perovskite-based quantum dots (QD) known to have high light emission efficiency can be used, for which cesium lead halide (CsPbBr₃) perovskite quantum dots and the like can be used. In the present invention, the material of the quantum dot film applied to the augmented reality device includes, in addition to the above-described material, any of the molecular unit materials of a size of several tens of micrometers or less that exhibits a photo luminescence phenomenon based on a quantum mechanical energy level splitting phenomenon.

In the present invention, the quantum dot used in the augmented reality device is mixed with light-reactive polymer, thermosetting polymer, material capable of forming a thin film by coating, polymer material capable of dispersion by mixing with a solvent, and monomer material, etc., and can be formulated in the form of a thin film or film through processes such as spin coating, die casting and stretching.

In the present invention, the quantum dot element used in the augmented reality device may be deposited or coated in the form of coating on the film or substrate.

In the present invention, the quantum dot element used in the augmented reality device may be included in the micro-display or on the substrate in the form of a film or a coated, deposited, or coated plate.

The DOE element used in the augmented reality device of the present invention may be consisted of an element formed in a concentric circle or grating shape having a one-dimensional, two-dimensional, or three-dimensional periodic distribution of the height of a wedge-shaped, step-shaped, or periodic trigonometric function shaped in the thickness distribution of the element by a mechanical processing method.

The HOE element used in the augmented reality device of the present invention can be made of a flat film-like element forming a concentric circle or grating-shaped refractive index distribution pattern having a one-dimensional, two-dimensional or three-dimensional periodic distribution of the height of a periodic trigonometric function shape film in the refractive index distribution using a laser light interference method.

The optical system used in the augmented reality device of the present invention includes all optical systems, such as a prism coupler type optical system, a free space mirror arrangement type optical system, a wave guide type optical system including various light incident or extraction patterns, a beam splitter type optical system (bird bath type) optical system, reflection type pin mirror type optical system, transmission type pinhole type optical system, and laser scanning mirror type optical system.

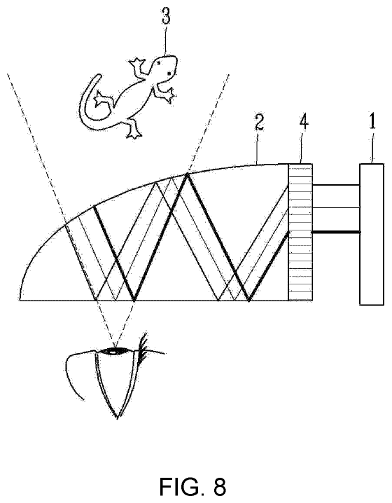

FIG. 8 is a diagram schematically showing a configuration in which an HOE or DOE is attached to one side of a transmission optical system in an optical system of an augmented reality device according to the present invention.

Referring to FIG. 8, it is a diagram schematically showing a configuration in which an HOE or a DOE is attached to one side of a transmission optical system of an augmented reality device according to the present invention. By this configuration, the aberration of the image light irradiated from the micro-display is reduced, and the clearer image light is transmitted to the transmission optical system, which makes it possible to implement a clearer augmented reality image.

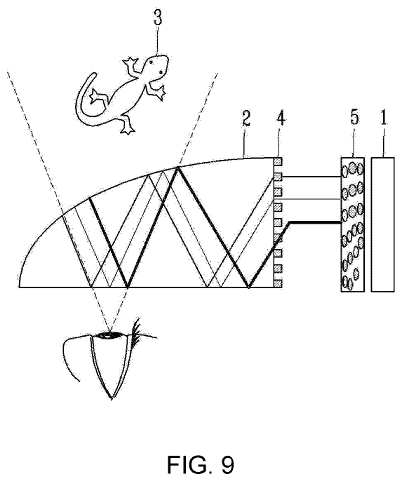

FIG. 9 is a view showing the AR optical system structure of the present invention in which a quantum dot (QD) film is installed in front of a micro-OLED element in a prism coupler-type augmented reality optical system to reduce the line width and to increase the diffraction efficiency of a DOE or HOE element.

As can be seen in FIG. 9, the optical system of the augmented reality device according to an embodiment of the present invention includes a micro-display 1, a quantum dot film 5, a diffractive optical element 4, and a transmission optical system (2) to which a prism coupler is applied. The diffractive optical element 4 may use either DOE or HOE, but in this embodiment, an optical system employing HOE will be described as an example. As shown in the drawing, the quantum dot film 5 may be disposed between the micro-display 1 and the diffractive optical element 4 or may be disposed between the diffractive optical element 4 and the transmission optical system 2.

In another embodiment of the present invention, in order to reduce the line width of a micro-OLED display device in an augmented reality device, Perovskite-based QD (CH₃NH₃Pb(I₁ₓBrₓ)₃, CH₃NH₃PbBr₃) particles are dispersed in a photocurable polymer and coated to form a film. After that, an augmented reality display device composed of a quantum dot film formed by irradiating UV, a DOE having a grating shape to give an aberration reduction effect, and an optical combining element of a prism coupler type is constructed.

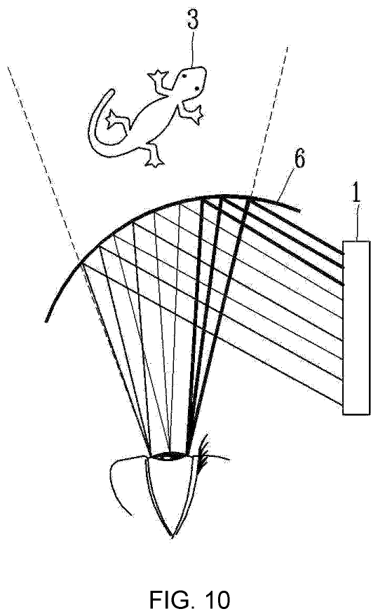

FIG. 10 is a diagram schematically showing an optical system of an augmented reality device including a reflective combiner in free space according to the present invention.

Referring to FIG. 10, when the image light irradiated from the micro-display 1 is reflected by the reflective combiner 6 and enters the user's eyes, an augmented reality image 3 is formed in front of the user. In this case, the image light irradiated from the micro-display does not pass through the medium of the prism and is reflected on the free space to form the augmented reality image 3, so it is called a free space optical method.

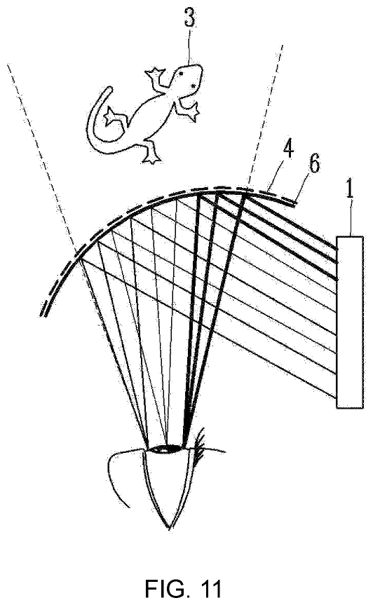

FIG. 11 is a diagram schematically showing a configuration in which HOE or DOE 4 is attached to one side of the reflective combiner 6 in the optical system of the augmented reality device including the reflective combiner 6 in free space according to the present invention.

In this way, by reducing the aberration of the image light reflected from the reflective combiner 6, it is possible to implement a clearer augmented reality image 3.

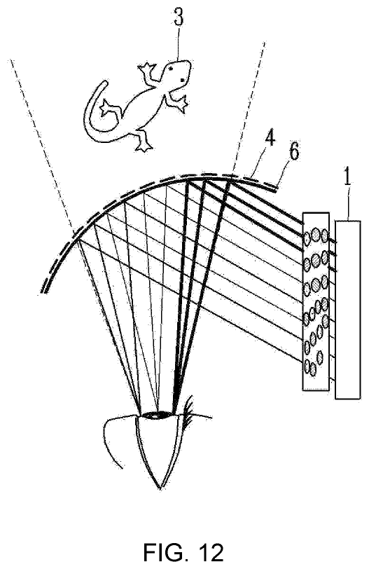

FIG. 12 is a view showing a configuration in which a QD film is installed on the front of a micro-OLED device in an augmented reality device of a free space optical system method.

As can be seen in FIG. 12, the optical system of the augmented reality device including the reflective combiner in free space according to an embodiment of the present invention includes a transmission optical system to which a micro-display, a quantum dot film, a diffractive optical element, and a reflective combiner are applied. Both DOE and HOE can be used as the diffractive optical element, but in this embodiment, an optical system employing HOE will be described as an example. As shown in the drawing, the quantum dot film may be disposed between the micro-display and the diffractive optical element, or may be disposed between the diffractive optical element and the reflective combining element. In either case, the line width of the image light irradiated by the QD film is reduced to increase the diffraction efficiency of the DOE device.

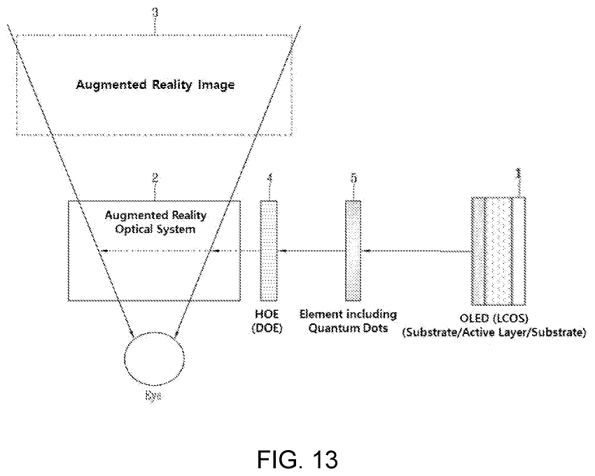

FIG. 13 is a diagram showing the basic structure of the present invention in which quantum dot elements are disposed in an optical path between a micro-display and a holographic optical element or a diffractive optical element in an augmented reality display system.

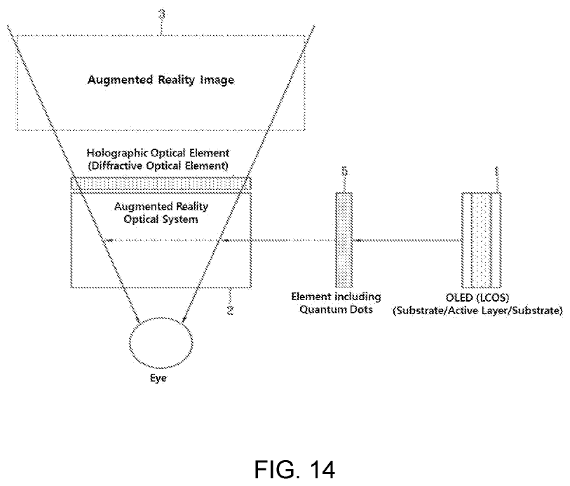

FIG. 14 is a diagram showing that quantum dot elements are disposed between a micro-display and a holographic optical element or diffractive optical element when the holographic optical element or the diffractive optical element is positioned between the augmented reality optical system and an eye in the augmented reality display system according to an embodiment of the present invention.

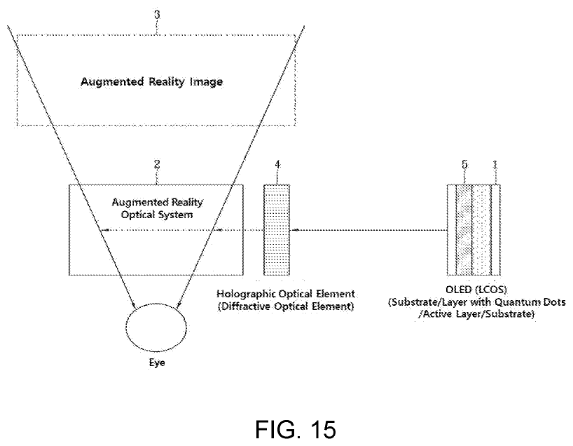

FIG. 15 is a diagram illustrating a case where an element including a quantum dot element is disposed in an internal active layer of a micro-display in an augmented reality display system according to an embodiment of the present invention.

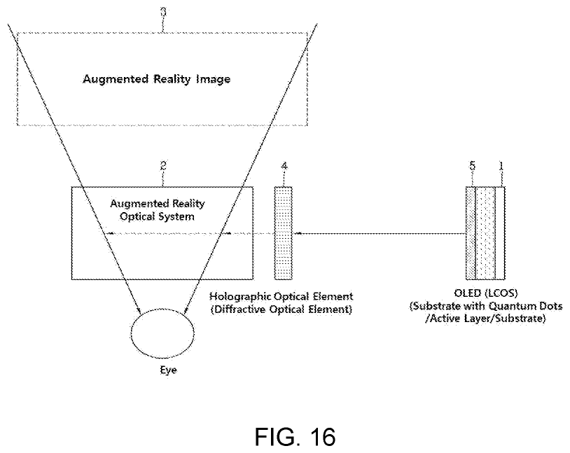

FIG. 16 is a diagram illustrating a case where a quantum dot element is disposed inside a substrate of a micro-display in an augmented reality display system according to an embodiment of the present invention.

It will be clear to those skilled in the art that the above-described present invention is not limited by the above-described embodiments and the accompanying drawings, and various substitutions, modifications, and changes are possible within the scope of the technical spirit of the present invention in the technical field to which the present invention belongs.

1. An augmented reality device including a micro-display, an optical system to transfer the light from the micro-display via a predetermined light path, a diffractive optical element and/or a holographic optical element, wherein
an element including a quantum dot material is disposed at one position of the paths of the light that is emitting from a micro-display and that is incident to a diffractive optical element and/or a holographic optical element.

2. The augmented reality device of claim 1, wherein the micro-display includes one of an OLED, a LCOS, a LCD, a DMD, an inorganic LED, a laser beam scanning mirror type display, and a fiber scanning type display.

3. The augmented reality device of claim 1, wherein the diffractive optical element is an element in which a height pattern of a one-dimensional or two-dimensional grating structure is formed using an optical material.

4. The augmented reality device of claim 1, wherein the holographic optical element is an element in which a refractive index distribution pattern of a one-dimensional or two-dimensional grating structure is formed using an optical material.

5. The augmented reality device of claim 1, wherein the element including the quantum dot includes a device made of a material with a molecular unit size of tens of micrometers or less that exhibits a photoluminescence phenomenon based on quantum mechanical energy level splitting, including a CdSeS/ZnS alloyed quantum dot, CdSe/ZnS core-shell type quantum dot, CdSe/ZnS core-shell type quantum dot, CdTe core-type quantum dot, PbS core-type quantum dot, perovskite series quantum dot such as cesium lead halide, and a quantum dot made of compounds that does not contain Cd.

6. The augmented reality device of claim 1, wherein the element including the quantum dot is an element dispersed in a polymer or glass material and provided in the form of a film, a coating or a plate.

7. The augmented reality device of claim 1, wherein the element including the quantum dot is included in the form of a dispersion inside the micro-display or on the substrate, or in the form of a coating or a film.

8. The augmented reality device of claim 1, wherein the transmission optical system includes an optical system composed of one of more elements of spherical, aspherical, or free curved lens, a prism or a mirror, a free space reflection mirror type optical system, a beam splitter type optical system, a reflective or transmissive pin-hole type optical system, a waveguide type optical system, a waveguide type optical system having a patterning structure or a mirror array structure, and a bird-bath-type optical system.

9. An augmented reality device of an all-in-one type or a tethered type, applying the augmented reality device of claim 1.

10. The augmented reality device of claim 2, wherein the diffractive optical element is an element in which a height pattern of a one-dimensional or two-dimensional grating structure is formed using an optical material.

11. The augmented reality device of claim 2, wherein the holographic optical element is an element in which a refractive index distribution pattern of a one-dimensional or two-dimensional grating structure is formed using an optical material.

12. The augmented reality device of claim 2, wherein the element including the quantum dot includes a device made of a material with a molecular unit size of tens of micrometers or less that exhibits a photoluminescence phenomenon based on quantum mechanical energy level splitting, including a CdSeS/ZnS alloyed quantum dot, CdSe/ZnS core-shell type quantum dot, CdSe/ZnS core-shell type quantum dot, CdTe core-type quantum dot, PbS core-type quantum dot, perovskite series quantum dot such as cesium lead halide, and a quantum dot made of compounds that does not contain Cd.

13. The augmented reality device of claim 2, wherein the element including the quantum dot is an element dispersed in a polymer or glass material and provided in the form of a film, a coating or a plate.

14. The augmented reality device of claim 2, wherein the element including the quantum dot is included in the form of a dispersion inside the micro-display or on the substrate, or in the form of a coating or a film.

15. The augmented reality device of claim 2, wherein the transmission optical system includes an optical system composed of one of more elements of spherical, aspherical, or free curved lens, a prism or a mirror, a free space reflection mirror type optical system, a beam splitter type optical system, a reflective or transmissive pin-hole type optical system, a waveguide type optical system, a waveguide type optical system having a patterning structure or a mirror array structure, and a bird-bath-type optical system.

16. An augmented reality device of an all-in-one type or a tethered type, applying the augmented reality device of claim 2.
